(19) United States
(12) Patent Application Publication
(10) Pub. No.: US 2020/0027043 A1
(43) Pub. Date: Jan. 23, 2020

(54) CONSTRUCTION PROJECT MANAGEMENT SYSTEM AND METHOD THEREOF

(71) Applicant: Stoa Fund Ltd., Tel Aviv (IL)

(72) Inventors: Or AGASSI, Tel Aviv (IL); Tom SELLA, Miami, FL (US)

(73) Assignee: Stoa Fund Ltd., Tel Aviv (IL)

(21) Appl. No.: 16/519,611

(22) Filed: Jul. 23, 2019

Related U.S. Application Data
(60) Provisional application No. 62/701,845, filed on Jul. 23, 2018.

(51) Int. Cl. G06Q 10/06; G06Q 20/10; G06F 16/2455

(52) U.S. Cl. CPC G06Q 10/06313; G06F 16/2455; G06Q 20/10

(57) ABSTRACT

A construction management system and method thereof. The system comprising: a processing circuitry; and a memory, the memory containing instructions that, when executed by the processing circuitry, configure the system to: analyze a project data of at least one construction project; based on the analysis of the project data, derive metadata associated with the construction project, wherein the metadata designates at least various stages associated with the construction project and a completion threshold for each stage; and based on the metadata, generate an interface for allowing at least two end-user devices to collaboratively interact with the interface, wherein the interface provides interactive visual features indicative of a progress of each of the stages associated with the construction project.

### CROSS-REFERENCE TO RELATED APPLICATIONS

This application claims the benefit of U.S. Provisional Application No. 62/701,845 filed on Jul. 23, 2018, the contents of which are hereby incorporated by reference.

### TECHNICAL FIELD

The present disclosure relates generally to communication platforms, and more specifically to a system and methods for automatically allocating communication channels between an investor and one or more vendors with respect to a certain project.

### BACKGROUND

Even though technology became available in most industrial areas, in the real-estate domain a massive use of manual labor to perform tedious and costly steps still take place.

House flipping is a type of real estate investment strategy in which an investor purchases real estate properties with the goal of reselling them for a profit. Profit is generated either through price appreciation, developments, and/or capital improvements. Investors who employ these strategies face the risk of price depreciation in bad housing markets.

Investors who flip houses expect to generate a relatively high return on houses purchased but may encounter cash-flow difficulties due to the nature of such strategies. Further, investors who flip houses typically need to manage the improvement construction project remotely. This includes collecting estimates from vendors, scheduling with various vendors, and monitoring the quality and progress of the work. Therefore, communication with vendors and having succinct monitoring of their progress is most important. Currently, there are no tools that allow for the centralized management of such project. All communication is performed by phone calls or text messages. The inventors (owner of the project) has no real time indication if any work is performed on-site and what is the progress of each job.

It would be therefore advantageous to provide a solution that allows for the centralized management of the construction project.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for analyzing a project data of at least one construction project; based on the analysis of the project data, deriving metadata associated with the construction project, wherein the metadata designates at least various stages associated with the construction project and a completion threshold for each stage; and based on the metadata, generating an interface for allowing at least two end-user devices to collaboratively interact with the interface, wherein the interface provides interactive visual features indicative of a progress of each of the stages associated with the construction project.

Certain embodiments disclosed herein also include a non-transitory computer readable medium having stored thereon causing a processing circuitry to execute a process, the process comprising: analyzing a project data of at least one construction project; based on the analysis of the project data, deriving metadata associated with the construction project, wherein the metadata designates at least various stages associated with the construction project and a completion threshold for each stage; and based on the metadata, generating an interface for allowing at least two end-user devices to collaboratively interact with the interface, wherein the interface provides interactive visual features indicative of a progress of each of the stages associated with the construction project.

Certain embodiments disclosed herein also include a construction management system comprising a processing circuitry; and a memory, the memory containing instructions that, when executed by the processing circuitry, configure the system to: analyze a project data of at least one construction project; based on the analysis of the project data, derive metadata associated with the construction project, wherein the metadata designates at least various stages associated with the construction project and a completion threshold for each stage; and based on the metadata, generate an interface for allowing at least two end-user devices to collaboratively interact with the interface, wherein the interface provides interactive visual features indicative of a progress of each of the stages associated with the construction project.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic network diagram utilized to describe the various disclosed embodiments.

FIG. 2 is a flowchart describing a method for generating a designated communication channel between an investor and one or more vendors according to an embodiment.

FIG. 3 is a screenshot of a designated interface for communication between an investor and one or more vendors according to an embodiment.

FIG. 4 is an example block diagram of a construction management system 130 according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for associating at least a first end point device (EPD) associated with a vendor and at least one a second EPD associated with an investor for a certain time period. The system further enables configuration of one or more communication channels via the at least a first EPD and the at least a second EPD. Upon identification that the time period has terminated, the system terminates the communication channels.

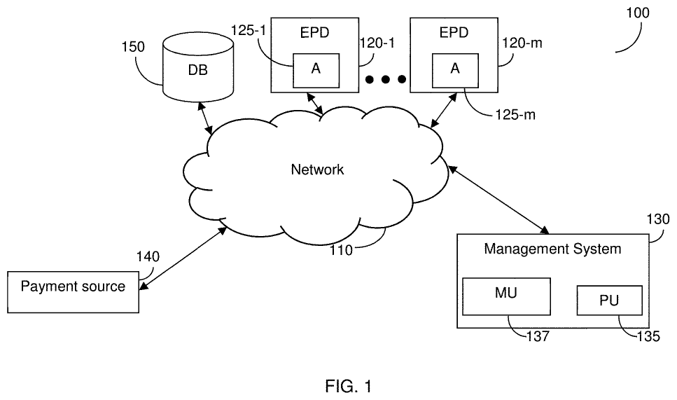

FIG. 1 is an exemplary and non-limiting schematic diagram of a system 100 for generating a designated communication channel respective of a project according to an embodiment. A network 110 is used to communicate between different parts of the system 100. The network 110 may be the Internet, the world-wide-web (WWW), a local area network (LAN), a wide area network (WAN), a metro area network (MAN), and other networks capable of enabling communication between the elements of the system 100.

One or more end point devices (EPDs) 120-1 through 120-m (wherein ‘m’ is an integer greater than 1) are further connected to the network 110. An EPD 120 may be, for example: a personal computer (PC), a personal digital assistant (PDA), a mobile phone, a smart phone, a tablet computer, an electronic wearable device (e.g., glasses, a watch, etc.), a smart television and other kinds of wired and mobile appliances, equipped with browsing, viewing, capturing, storing, listening, filtering, and managing capabilities enabled as further discussed herein below.

Each EPD 120 may further include a software application (App) 125 installed thereon. A software application App 125 may be downloaded from an application repository, such as the AppStore®, Google Play®, or any repositories hosting software applications. The application 125 may be pre-installed in the EPD 120. In one embodiment, the application 125 is a web-browser.

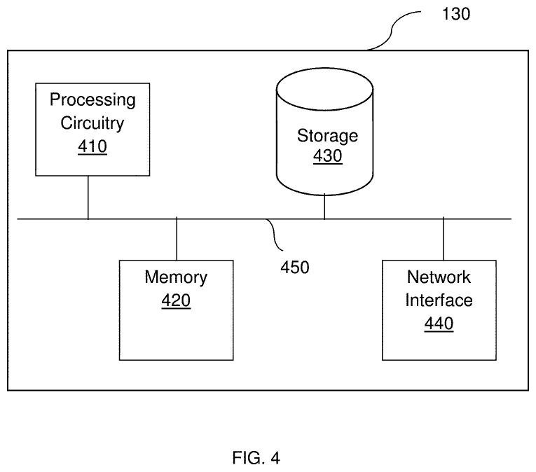

A construction project management system 130 (hereinafter the system 130) is connected to the EPDs 120, through the network 110. The applications 125 can communicate with the system 130 over the network 110. A block diagram of the system 130 is discussed with reference to FIG. 4.

It should be noted that only a first EPD and a second EPD are discussed herein merely for the sake of simplicity. However, the embodiments disclosed herein are applicable to a plurality of EPDs that can communicate with the system 130 via the network 110.

Also communicatively connected to the network 110 is at least one payment source 140. The payment source 140 may be, for example: a web page, a cloud-based interface, etc. accessible to the EPDs 120 over the network 110. The payment source 140 may be an online payment processor, such as PayPal®, ApplePay®, Venmo, and/or credit card payment processing.

A metadata database 150 that stores metadata related to property transactions and construction projects is further connected to the network 110. In the embodiment illustrated in FIG. 1, the system 130 communicatively communicates with the metadata database 150 through the network 110.

According to an embodiment, the system 130 receives a request from a first EPD 120-1 to generate a designated communication channel on the payment source 140 between an investor and at least one vendor with respect to at least one project. The request includes at least project data. According to an example, the project data may include the type of project and location of a property. The project type can be selected from a closed predetermined list suggested, e.g., kitchen renovation, landscape, bedroom renovation, exterior, a combination thereof and so on.

According to an embodiment, the first EPD 120 is associated with a first type of user (e.g. an investor) and a second EPD 120-2 is associated with a second type of user (e.g., a vendor). A construction project includes multiple steps or stages, each such stage has a predetermined target date or milestone (hereinafter a completion threshold). As an example, a project may be a kitchen renovation and the stages include remove existing cabins, repair drywalls, replacement of the cabins, cleansing of the tiles, and so. Upon completion of each stage its completion threshold is met. It should be noted that the completion threshold may be set to the entire project. Payments to the vendor may be triggered by the completion of each stage.

According to the disclosed embodiment, the project data is analyzed by the system 130 and metadata related to the projected is derived. In an embodiment, the system 130 is configured to query a database with the project type. The returned results of the query includes metadata. The metadata may indicate the type of project, the various stages of the project, a completion threshold for each stage, an end threshold for the entire project, type of materials required in each stage, budget constraints, payment terms, and so on. In an embodiment, the contents of the metadata database 150 may be populated by vendors or investors overtime. The contents of the metadata database 150 is updated upon completion of each project.

Based on the metadata, the system 130 is configured to generate and display the interface to both EPDs. The interface may be a web interface such as a form or a webpage, a web portal, and the like. The interface provides a plurality of interactive visual features. In an embodiment, each such interactive visual feature is indicative of a stage in the project and its progress. According to the above-mentioned example, in the project of the kitchen renovation, a time bar may be generated for the cabin replacement and a second one for the tiles cleaning.

According to an embodiment, the interface provides communication means between the investor via the first EPD 120-1 and the vendor via the second EPD 120-2 such as, for example: chat, voice, MMS, a combination thereof, and so on. In an embodiment, a direct communication channel is established between the EPDs 120 to review and collaboratively interact with the interface.

Thereafter, the system 130 is configured to enable access to the first EPD 120-1 and the second EPD 120-2 to an interactive interface on the generated interface. The interface provides a plurality of interactive visual features. In an embodiment, each such interactive visual feature is indicative of a stage in the project and its progress.

In an embodiment, the system 130 is further configured to monitor the progress of each project to determine, at least, if a completion threshold of each stage has been met. Upon completion of each stage or of the entire project, the EPD of the investor user is directed to the payment source 140 to make a payment to the vendor.

It should be noted that in the example implementation shown in FIG. 1 the system 130 may be deployed in a cloud computing platform, a datacenter, and/or on-premises without departing from the scope of the disclosure.

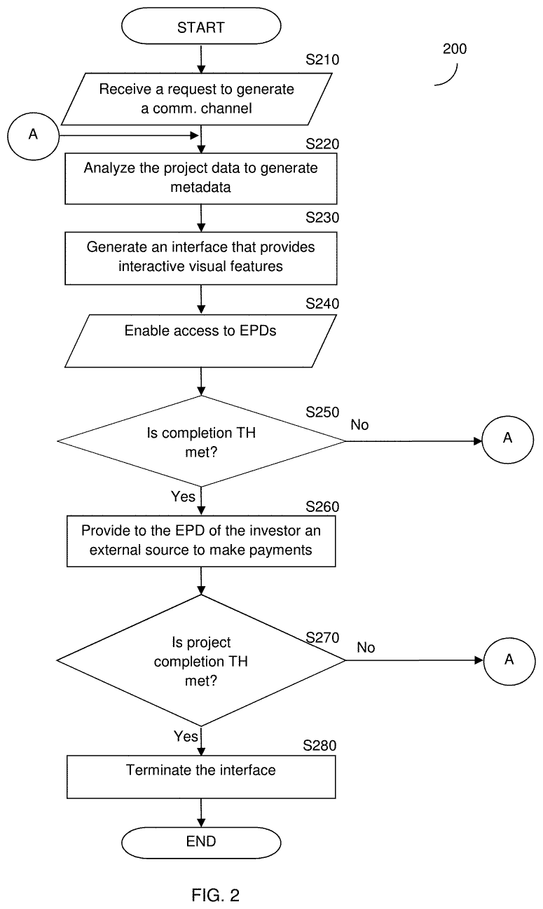

FIG. 2 depicts an example flowchart 200 describing a method for allocating a designated communication channel between an EPD of a first user and an EPD of a second user to the purpose of a construction project management. In an embodiment, the first user is an investor and the second user is a vendor providing services on a property acquired by the investor.

At S210, the operation starts when a request to generate a communication channel with respect of at least one project is received. According to another embodiment, the operation may start responsive of an upload of project data. The request includes at least project data. The project data may indicate the property address, and the type of the construction project. The request may be uploaded by an EPD of the investor. The request may also designate at least one vendor to work on the construction project.

At S220, the project data is analyzed, and metadata associated with the project is derived. The analysis may include querying a database with the project type. The results to the query may include the metadata. The metadata may indicate the type of project, the various stages of the project, a competition threshold for each stage, an end threshold for the entire project, type of materials required in each stage, budget constraints, payment terms, and so on. In an embodiment, the contents of the database may be populated by vendors or investors overtime. The contents of the database are updated upon completion of each project.

At S230, based on the derived metadata, an interface is generated and displayed to both EPDs. The interface may be a web interface, a form or a webpage, a web portal, and the like. The interface provides a plurality of interactive visual features. In an embodiment, each such interactive visual feature is indicative of a stage in the project and its progress.

At S240, access to the generated interface provided to the EPDs (in particular, the first and second EPDs 120-1 and 120-2) is enabled. In an embodiment, both an investor and a vendor can interact with the interface. This includes, for example: updating the status of each stage, modifying various parameters related to each stage, e.g., increasing/reducing budget, changing building materials, changing completion thresholds, and so on.

At S250, the progress of the project is monitored to determine at least if a completion threshold of each stage has been met. In an optional embodiment, at S260, upon completion of each stage, the investor's EPS is directed to an external resource to make a payment to the vendor. The external resource may include online payment processor, such as PayPal®, ApplePay®, Venmo®, credit card payment processing, etc. S250 and S260 are performed for each stage.

At S270, it is checked if the completion (end) threshold of the entire project has been met, if so, the interface is terminated; Otherwise, execution returns to S260. It should be noted that data (statistics) regarding the performance of each vendor with the respect to the project can be gathered. This may include, for example, if a vendor met or missed the thresholds, met or missed the budget allocated to each stage, and so on. Such performance data can be utilized to rank vendor. Further, in an embodiment, the performance data is utilized to update the metadata database.

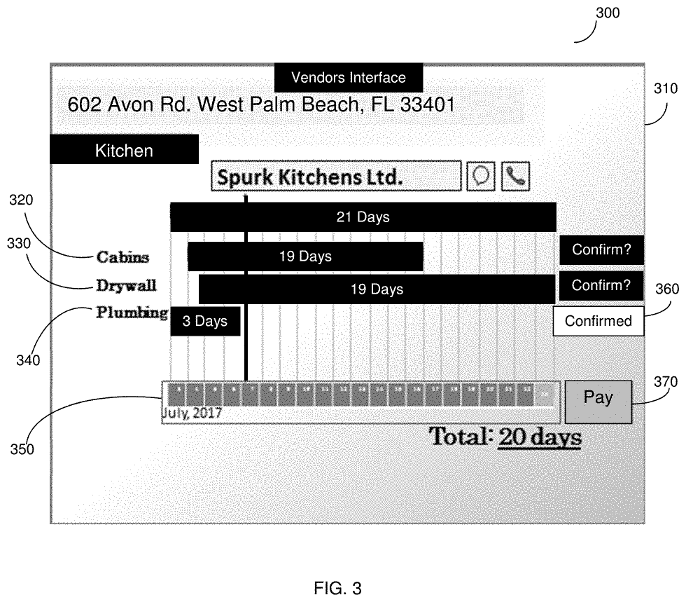

FIG. 3 depicts an example screenshot 300 of an interface 310 generated for a construction project according to an embodiment. In this example, the construction project is for renovation of a kitchen that includes the stages: drywalls 330, cabins 320, and plumbing 340.

The interface 310 further comprises a time bar 350. Upon completion of each stage, the completed stage is marked as confirmed (see button 360) by a user of the EPDs 120. That is, the stage may be marked completed by the investor, the vendor, or both. Upon completion of at least a portion of one or more of the stages, the investor is enabled to pay the vendor via the ‘Pay’ button 370.

FIG. 4 is an example block diagram of a system 130 according to an embodiment. The system 130 includes a processing circuitry 410 coupled to a memory 420, a storage 430, and a network interface 440. In an embodiment, the components of the system 130 may be communicatively connected via a bus 450.

The processing circuitry 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 420 may be volatile (e.g., RAM, etc.), non-volatile (e.g., ROM, flash memory, etc.), or a combination thereof. In one configuration, software for implementing one or more embodiments disclosed herein may be stored in the storage 430. In another configuration, the memory 420 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 410, cause the processing circuitry 410 to perform the various processes described herein.

The storage 430 may be magnetic storage, optical storage, and the like, and may be realized, for example, as flash memory or other memory technology, CD-ROM, Digital Versatile Disks (DVDs), or any other medium which can be used to store the desired information. The network interface 440 allows the system 130 to communicate with EPDs 120 and other web resources.

It should be understood that the embodiments described herein are not limited to the specific architecture illustrated in FIG. 4, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A construction management system, comprising:
a processing circuitry; and
a memory, the memory containing instructions that, when executed by the processing circuitry, configure the system to:
analyze a project data of at least one construction project;
based on the analysis of the project data, derive metadata associated with the construction project, wherein the metadata designates at least various stages associated with the construction project and a completion threshold for each stage; and
based on the metadata, generate an interface allowing at least two end-user devices to collaboratively interact with the interface, wherein the interface provides interactive visual features indicative of a progress of each of the stages associated with the construction project.

2. The system of claim 1, wherein the system is further configured to:
monitor the progress of each stage; and
update a respective interactive visual feature based on the monitored progress.

3. The system of claim 1, wherein the system is further configured to:
initiate a payment transaction for a first end-user device to a second end-user device of the at least two end-user devices.

4. The system of claim 3, wherein the first end-user device is associated with an investor and the second end-user device is associated with a vendor.

5. The system of claim 1, wherein the metadata further includes: type of materials required in each stage, budget constraints, and payment terms.

6. The system of claim 5, wherein the system is further configured to:
query a metadata database with the project data to derive the metadata of the construction project.

7. The system of claim 6, wherein the system is further configured to:
generate performance data upon completion of the construction project; and
update the metadata database using the performance data.

8. A method managing a construction project, comprising:
analyzing a project data of at least one construction project;
based on the analysis of the project data, deriving metadata associated with the construction project, wherein the metadata designates at least various stages associated with the construction project and a completion threshold for each stage; and
based on the metadata, generating an interface for allowing at least two end-user devices to collaboratively interact with the interface, wherein the interface provides interactive visual features indicative of a progress of each of the stages associated with the construction project.

9. The method of claim 8, further comprising:
monitoring the progress of each stage; and
updating a respective interactive visual feature based on the monitored progress.

10. The method of claim 9, further comprising:
initiate a payment transaction for a first end-user device to a second end-user device of the least two end-user devices.

11. The method of claim 10, wherein the first end-user device is associated with an investor and the second end-user device is associated with a vendor.

12. The method of claim 11, wherein the metadata further includes: type of materials required in each stage, budget constraints, and payment terms.

13. The method of claim 12, further comprising:
query a metadata database with the project data to derive the metadata of the construction project.

14. The method of claim 14, further comprising:
generating performance data upon completion of the construction project; and
updating the metadata database using the performance data.

15. A non-transitory computer readable medium having stored thereon instructions for causing a processing circuitry to execute a process, the process comprising:
analyzing a project data of at least one construction project;
based on the analysis of the project data, deriving metadata associated with the construction project, wherein the metadata designates at least various stages associated with the construction project and a completion threshold for each stage; and
based on the metadata, generating an interface allowing at least two end-user devices to collaboratively interact with the interface, wherein the interface provides interactive visual features indicative of a progress of each of the stages associated with the construction project.
